(19) United States
(12) Patent Application Publication
(10) Pub. No.: US 2016/0138908 A1
(43) Pub. Date: May 19, 2016

(54) MICROMECHANICAL PHOTOTHERMAL ANALYSER OF MICROFLUIDIC SAMPLES

(71) Applicant: DANMARKS TEKNISKE UNIVERSITET, Lyngby (DK)

(72) Inventors: Muhammad Faheem Khan, Edmonton (CA); Silvan Schmid, Copenhagen S (DK); Anja Boisen, Birkerød (DK); Seonghwan Kim, Edmonton (CA); Thomas Thundat, Edmonton (CA)

(21) Appl. No.: 14/899,457

(22) PCT Filed: Jun. 26, 2014
(86) PCT No.: PCT/DK2014/050192

§ 371 Date: Dec. 17, 2015

(30) Foreign Application Priority Data
Jun. 26, 2013 (EP) 13173787.6

(51) Int. Cl. G01B 11/16; G01N 21/31

(52) U.S. Cl. CPC G01B 11/16; G01N 21/31; G01N 2201/06113

(57) ABSTRACT

The present invention relates to a micromechanical photothermal analyser of microfluidic samples comprising an oblong micro-channel extending longitudinally from a support element, the micro-channel is made from at least two materials with different thermal expansion coefficients, wherein the materials are arranged relatively to each other so that heating of the micro-channel results in a bending of the micro-channel, the first material has a first thermal expansion coefficient and is made from an light-specific transparent penetrable material so that when exposed to ultraviolet, visible, or infrared light, the specific light radiates into the channel through said light transparent material, the second material has a second thermal expansion coefficient being different from the first thermal expansion coefficient. The micromechanical photothermal analyser also comprises an irradiation source being adapted to controlled radiate ultraviolet, visible, or infrared light towards and through the transparent micro-channel, and a deflection detector being adapted to detect the amount of deflection of the micro-channel. The wavelength-deflection plot provides a spectrum of an analyte inside the oblong microchannel. To characterize the analyte the plot is compared with the standard database of spectroscopy.

### FIELD OF THE INVENTION

The present invention relates to a micromechanical photothermal analyser of microfluidic samples, comprising an oblong micro-channel extending longitudinally from a support element, the micro-channel is made from at least two materials with different thermal expansion coefficients, wherein the materials are arranged relatively to each other so that heating of the micro-channel results in a bending of the micro-channel, the first material has a first thermal expansion coefficient and is made from a light-specific transparent penetrable material so that when exposed to ultraviolet (UV), visible (VIS), or infrared (IR) light, the specific-light radiates into the channel through said light transparent material, the second material has a second thermal expansion coefficient being different from the first thermal expansion coefficient. The micromechanical photothermal analyser also comprises an irradiation source being adapted to radiate UV, VIS, or IR light towards and through the transparent micro-channel, and a deflection detector being adapted to detect the amount of deflection of the micro-channel.

### BACKGROUND OF THE INVENTION

The analysis of small volumes of liquid by light absorption techniques, such as infrared spectroscopy or UV-VIS absorption spectroscopy, remains as a formidable challenge.

Fino E et al discloses in the article “Visible photothermal deflection spectroscopy using microcantilevers” (Sensor and Actuators B 169 (2012) 222-228, Elsevier) a flat cantilever with a rectangular cross section. This cantilever lacks a capability to analyze liquids and/or gases. The cantilever disclosed is composed from a bare silicon microcantilever coated with gold.

US 2005/064581 disclose an apparatus for detecting an analyte that has a suspended beam containing at least one microfluidic channel containing a capture ligand that bonds to or reacts with an analyte. The method disclosed, aims at determining an amount bound by measuring the change in resonant frequency during the adsorption.

However, none of method disclosed have been found suitable for analyzing liquid or gaseous substance by use of absorption spectroscopy.

Hence, an improved device and method for absorption spectroscopy of liquid and gas samples, preferably in the nano or pico-liter volume range would be advantageous, and in particular a more efficient and/or reliable analytical device and method would be advantageous.

### OBJECT OF THE INVENTION

It is a further object of the present invention to provide an alternative to the prior art.

In particular, it may be seen as an object of the present invention to provide a micron-scale analyser that solves the above mentioned problems of the prior art.

### SUMMARY OF THE INVENTION

Thus, the above described object and several other objects are intended to be obtained in a first aspect of the invention by providing a micromechanical photothermal analyser of microfluidic samples comprising:
an oblong micro-channel extending longitudinally from a support element, the micro-channel is made from at least two materials with different thermal expansion coefficients, wherein the materials are arranged relatively to each other so that heating of the micro-channel results in a bending of the micro-channel,
   the first material has a first thermal expansion coefficient and is made from a light-specific transparent penetrable material so that when exposed to UV, VIS, or IR light, the specific light radiates into the channel through said light-specific transparent material,
   the second material has a second thermal expansion coefficient being different from the first thermal expansion coefficient,
an irradiation source being adapted to radiate, preferably in a controlled manner, UV, VIS, or IR light towards and through the first material,
a deflection detector being adapted to detect the amount of deflection of the micro-channel.

The irradiation source is preferably adapted of controlled radiation, e.g. where the wavelength and/or pulsation is controlled in a predefined manner.

As it appears from the description of the invention herein, the micromechanical, and in particular the micro-channel, may be orientated in space, during use, with its longitudinal direct being horizontal (as shown in the figures). Thus, the oblong micro-channel may be characterised as a bi-material cantilever, where the cantilever comprising two longitudinal extending layers with different thermal expansion coefficient. As presented herein, the interior of the micro-channel (also extending longitudinal) may preferably be formed inside one of such layers.

The bending of the micro-channel by heating is typically provided by the micro-channel comprising a first wall segment and a second wall segment (having different thermal expansion coefficient), where the first wall segment extends longitudinally along the second wall segment.

In preferred embodiment, the first material is transparent such as semitransparent to one or more of: visible light, ultraviolet and infrared light.

In preferred embodiments, the thermal expansion coefficient of the first material (first thermal expansion coefficient) is larger than the thermal expansion coefficient of the second material (second thermal expansion coefficient).

In other preferred embodiments, the thermal expansion coefficient of the first material (first thermal expansion coefficient) is smaller than the thermal expansion coefficient of the second material (second thermal expansion coefficient).

Thermal expansion coefficient as used herein, is used in a manner being ordinary to the skilled person.

A micromechanical photothermal analyser of microfluidic samples according to the present invention may be used to analyse a fluid, such as a gas or a liquid, to reveal one or more characteristics of the fluid thereby characterising the fluid. Accordingly, the term analyser is to be understood in broad terms to include the meaning detector, analyser, sensor, etc.

An important feature of the present invention may be seen to be a photothermal detector, in the form of the oblong micro-channel which is based on or constituted by a bimaterial micro-channel, for the analysis of microfluidic samples. This detector can e.g. be used to record a photothermal IR spectrum of a substance inside a micro-channel when scanning the wavelength of the probing light.

However, the light may be other types of lights and it is envisaged that the invention is not limited to use within the IR range. E.g. concentrations of organic molecules in water may typically be measured with UV absorption measurements, and e.g. highly efficient fluorescence methods are working in the visible range.

In a particular aspect, an IR spectroscopic technique based on calorimetry for characterization of picoliter volume of liquids contained in a micro-channel that is temperature sensitive is demonstrated. IR absorption by liquid analyte in the channel creates minute heat that causes the oblong micro-channel to bend as a function of illuminating IR producing a nonmechanical IR absorption spectrum. This technique overcomes the sample volume limitation of current IR microspectroscopy and can be integrated into microfluidic devices allowing for an online sample analysis. In addition, the micro-channel geometry allows the precise measurements of the density of the liquid sample by monitoring the resonance frequency of the micro-channel. Significant and intriguing applications, such as drug development and screening, direct monitoring of byproducts from a micro bio-reactor, or the study of cells and microbes, are anticipated by the integration of more sophisticated microfluidics with this calorimetric IR microspectroscopy.

As there exist a correlation between the deflection of the micro-channel and the absorbed/heat generated in the micromechanical photothermal analyser according to the present invention, such analysers may be applied for numerous purposes.

An analyser according to the invention may successfully identify different substances (using their small amounts) based on the light-wavelength dependent deflection (as these may be seen as a unique finger print for each substance). An analyser according to the invention may also be used to monitor activities of bio cells due to their production of heat during growth. Additionally chemical reaction by mixing minute amounts (picoliters) of two different chemicals (compatible to the material of the device) can also be monitored by an analyser according to the present invention. An analyser according to the invention may further be used to monitor the concentration of chemical compounds in the microfluidic sample by UV-VIS absorption measurements.

In the present context, terms are used in a manner being ordinary to a skilled person. However, some the used terms are explained in some details below:

Light-specific transparent penetrable material is preferably used to denote a material being transparent to a specific and selected window of wavelengths.

Micron-scale or micro-sized is preferably used to denote element(s) having a size in the micron meter range scale i.e. having dimension in the range of 10⁻⁶ m.

Micro-channel is preferably used to denote a channel having a longitudinal extension in the micro meter to milli meter range as well as having a cross section in the nano meter to micro meter range. Further, micro-channel is preferably used to denote a microfluidic channel having a closed cross section. A micro-channel is tubular shaped in the sense that it is not open to exterior of the micro-channel except at inlet(s)/outlet(s).

Microfluidic is preferably used to denote a volume in the femto litre to micro litre range

Nano-scale or nano-sized is preferably used to denote element(s) having a size in the nano meter range scale, i.e. having dimensions in the range of 10⁻⁹ m.

Micromechanical photothermal analyser is preferably used to mean a device adapted to perform photothermal analysis as disclosed herein and being based on an oblong micro-channel being micron or nano sized.

Oblong micro-channel is preferably used to mean a fluid channel in the form of an elongate member anchored at only one end at a support element. An oblong micro-channel may also be described as and single clamped structure. Oblong micro-channel and micro-channel is preferably used interchangeably herein.

Oblong is used to denote an element having a length being larger than both the width and height of the element.

Orientations given herein are preferably given with respect to the orientation of the elements presented in the figures. While the figures presents preferred orientation of the elements with gravity pointing downwards, it is noted that the elements may be orientated differently during use.

The present invention relates in a second aspect to a photothermal analysis method using a micromechanical photothermal analyser according to the first aspect of the invention. The method preferably comprising
arranging a liquid—or in general a fluid—inside the micro-channel,
emitting UV, VIS, or IR light towards and through the first wall segment,
detecting by use of the deflection detector, the deflection of the micro-channel,
analysing the liquid (fluid) arranged inside the micro-channel based on the detected deflection.

The first and second aspect of the present invention may each be combined with any of the other aspects. These and other aspects of the invention will be apparent from and elucidated with reference to the embodiments described hereinafter.

Further, a micromechanical analyser has also the ability to analyse a sample it its solid state.

An advantageous feature of the present invention is that throughout the measurement—or analysing in general—the oblong micro-channel as well as analyte may be kept at atmospheric pressure and room temperature, while still allowing for other arranging the oblong micro-channel in other conditions.

Further embodiments are presented below and in the accompanying claims.

### BRIEF DESCRIPTION OF THE FIGURES

The present invention and in particular preferred embodiments thereof will now be disclosed in connection with the accompanying drawings. The drawings show ways of implementing the present invention and are not to be construed as being limiting to other possible embodiments falling within the scope of the attached claim set.

FIG. 1 discloses schematically an oblong micro-channel according to a first embodiment of the present invention,

FIG. 2 discloses schematically use of a micromechanical photothermal analyser according to the present invention and in particular device concepts referenced a, b, and c according to the present invention,

FIG. 3 discloses experimental setup according to the present invention,

FIG. 4 discloses experimental setup of infrared spectroscopy using a bimetallic oblong micro-channel.

FIG. 5 discloses schematically how a microchannel photothermal analyser can be used in an array configuration where multiple analysers are loaded with different solutions to perform a parallel analysis of the solutions.

FIG. 6 shows photographs of the experimental setup showing an IR light module (Quantum Cascade Laser), chip packaging, and readout laser. The insert shows top view of a chip with the readout laser focused at the tip of an oblong micro-channel.

FIG. 7 discloses IR spectra of 50 picoliters of an antimicrobial drug provided by the present invention,

FIG. 8 discloses sensitivity of the oblong micro-channel according to the present invention,

FIG. 9 discloses loading a sample existing in a solid state

FIG. 10 shows IR spectrum of SRN with micro-channel of the oblong micro-channel filled with air

FIG. 11 show IR spectrum of (a,b) n-Hexadecane (c,d) isopropanol (e,f) naphtha (g,h) paraffin

FIG. 12 disclose schematically an oblong micro-channel as in FIG. 1; the oblong micro-channel is provided with micro-pillars inside channel.

### DETAILED DESCRIPTION PREFERRED EMBODIMENTS

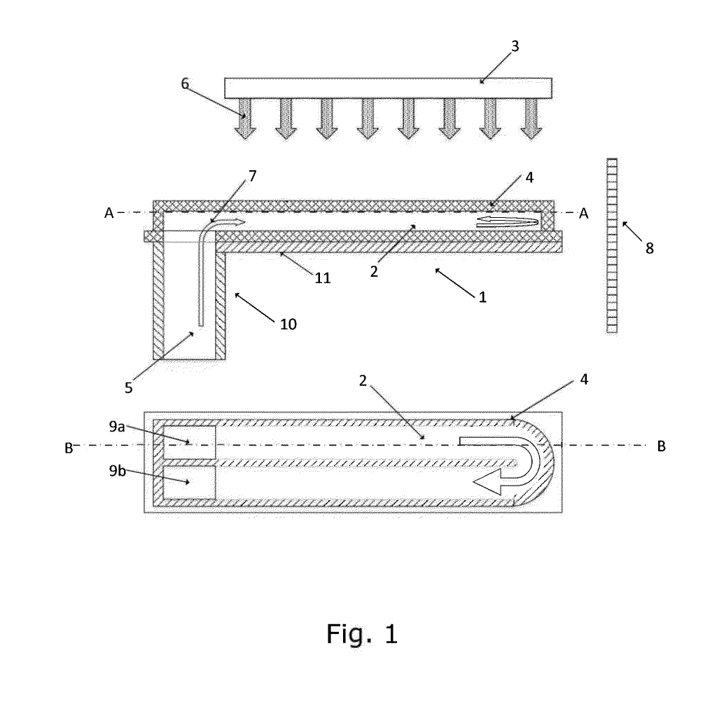

Reference is made to FIG. 1, which shows schematically a micro-channel according to a preferred embodiment of the invention. FIG. 1 upper part shows a vertical cross sectional view along line B-B of the lower part of FIG. 1 which shows a horizontal cross sectional view along line A-A in the upper part of FIG. 1.

The sample analysis is carried out based on deflection of a micro-channel due to thermal bending of the channel. With reference to FIG. 1, the oblong micro-channel 1 is U-shaped extending longitudinally, and preferably in a horizontal direction, from a support element 10. It is noted, that the U-shape is a preferred embodiment and that the oblong micro-channel 1 may be given other shapes deviating from the U-shape.

The micro-channel is made from at least two materials with different thermal expansion coefficients, wherein the materials are arranged relatively to each other so that heating of the micro-channel 1 results in a bending of the micro-channel 1. The first material has a first thermal expansion coefficient and is made from a light-specific transparent penetrable material so that when exposed to UV, VIS, or IR light, the specific light radiates into the channel 2 through said light-specific transparent material. The second material has a second thermal expansion coefficient being different from the first thermal expansion coefficient.

As shown in FIG. 1, the micro-channel 1 comprises a first wall segment 4 and a second wall segment 11 each forming at least a part of an upper respectively lower wall of the micro-channel 1. The first wall segment 4 extends longitudinally above—or in general along—the second wall segment 11 and wherein first wall segment 4 is made from the first material and the second wall segment 11 is made from the second material. As apparent from FIG. 1, the upper part of the first wall segment 4 allows infrared light to be radiated into the interior 2 of the channel 1.

The first wall segment 4 defines the interior 2 of the micro-channel 1 and the second wall segment 11 is arranged, such as constitute a coating, on a lower surface of the first wall segment 4, or, in general, arranged such as constitute a coating on a longitudinal extending surface of the first wall segment 4.

It can be realised from figures and the description accompanying these figures that for instance the wording “the first wall segment 4 extends longitudinally above the second wall segment 11” has the general meaning that the first wall segment 4 extends longitudinally along the second wall segment 11 (or vice versa). That also typically means that the two wall segments forms longitudinal extending elements (layers) of a cantilever. Similarly, “upper respectively lower wall”, e.g., refers to that the two walls are arranged as longitudinal extending elements of a cantilever. The orientation referred to herein may alternatively be in relation to the position of the irradiation source and the micro-channel relatively to each other. In such situations, the wall segment facing towards the irradiation source is typically the upper wall segment.

The liquid—or fluid in general—to be analysed is contained in the interior 2 of micro-channel 1 extending inside the oblong micro-channel 1 in the longitudinal direction of the oblong micro-channel 1.

The difference in thermal expansion coefficients of the two materials and their relative orientations results in a bending of the oblong micro-channel 1 if the temperature of the oblong micro-channel 1 deviates from a so-called equilibrium temperature, being the temperature at which the oblong micro-channel 1 is straight. This bending is used in the present invention to characterise a fluid arranged inside the channel 1 by heating the oblong micro-channel indirectly by heating the fluid by infrared radiation.

To accomplish the heating, the micromechanical photothermal analyser further comprising an irradiation source 3 being adapted to ray UV, VIS, or IR light 6 towards and through the first wall segment 4. Thereby, the fluid is heated which will cause a heating of the micro-channel 1 resulting in a bending thereof.

The irradiation source 3 is adapted to irradiate pulses or continuous beam of light. Furthermore, the irradiation source 3 is adapted to irradiate light at difference wavelengths. For the proof of concept, the IR source was able to emit IR from 6 μm to 12 μm in wavelength. Depending upon a material, only a selective range of IR wavelengths was used.

The amount of deflection is determined by a deflection detector 8 being adapted to detect the amount of deflection of the micro-channel 1. The deflection detector 8 comprising a laser emitting light towards the micro-channel in an oblique direction and a position sensitive detector arranged to receive the laser light reflected from the micro-channel (see also FIG. 4).

Fluid, such as liquid, is fed into and led out from the interior 2 of the micro-channel 1 by an inlet and an outlet. In many preferred embodiments, the fluid does not flow through the micro-channel 1 during analysing and the fluid is initially fed into the channel 2, heated and subsequently emptied out from the channel. However, the actual use of the micromechanical photothermal analyser is often dictated by the amount of sample available and it is envisaged that the micromechanical photothermal analyser may be used in way where the fluid flow through the micro-channel 1 during analysing.

As seen from FIG. 1, the interior 2 of the micro-channel 1 may be U-shaped with each branch extending in the longitudinal direction of the micro-channel 1, and an opening 9a, 9b, serving as inlet/outlet is provided at each branch of the micro-channel 1 distal to the bend of the U-shaped channel. The support element 10 5 contains two separate flow channels 5a, 5b (in FIG. 1, only numeral 5 is used to indicate the flow channels) each leading to one openings 9a, 9b thereby serving as inlet flow channel to and outlet flow channel from the branches of the U-shaped channel.

With reference to FIG. 1, a sample to be analysed flow through one of the flow channels 5a of the support element 10, through the opening 9a and into the channel 1—in FIG. 1, the flow pattern is shown by arrows one of which is indicated by numeral 7. Once the fluid enters the most downstream end of the channel, the bottom of the U-shape turns the fluid 180 degrees and the fluid flow towards the outlet 9b and the outlet flow channel 5b. The flow direction may be reverse.

A preferred selection of the material form which the micro-channel 1 is made is Silicon Nitride for the first wall segment 4 and metal or material coated with metal for the second wall segment 11. However, the selection of the material may differ from Silicon Nitride and/or metal coating. It is noted, that the absorption spectrum is measured of the material present in the interior of the micro-channel 2 and that the material of the micro-channel may not influence the absorption spectrum at all wavelengths.

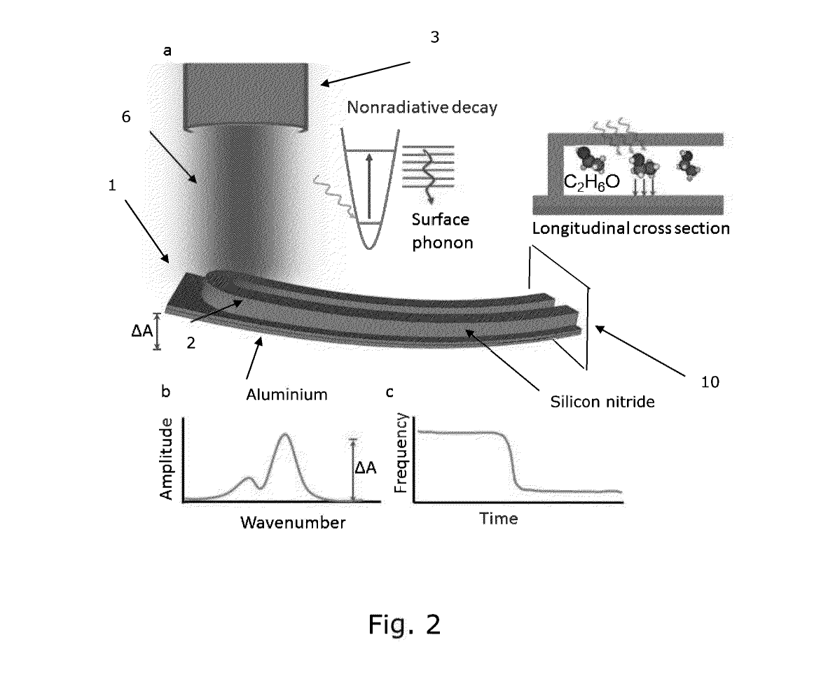

Reference is made to FIG. 2, which shows schematically use of an oblong micro-channel according to the present invention. FIG. 2 shows the micro-channel 1 bended (deflection marked by arrow and “AA”). FIG. 2 shows to the right a cross sectional view of the micro-channel 1. FIG. 2 lower part shows schematically, deflection as function of the wave number of the infrared light emitted and frequency as function of time. As a liquid enters the micro-channel, the resonance frequency decreases due to the additional mass of the liquid.

As shown in FIG. 2, the irradiation source 3 irradiates light 6 towards and into the interior 2 of the micro-channel 1 at different wave lengths. The micro-channel 1 is supported by the support element 10, which in the embodiment shown in FIG. 2 is a vertically extending wall element being anchored and sufficiently stiff so that movement of the micro-channel 1 is not induced by movement of the support element or movement of the micro-channel does not induce movement in the support element 10 (identical features are applied to the support element 10 in FIG. 1).

As the irradiation source 3 irradiates light into the fluid contained in the micro-channel 1, heating occurs at a specific wave length of the light (specific for a specific substance) which results in a bending of the micro-channel 1 as shown in FIG. 2.

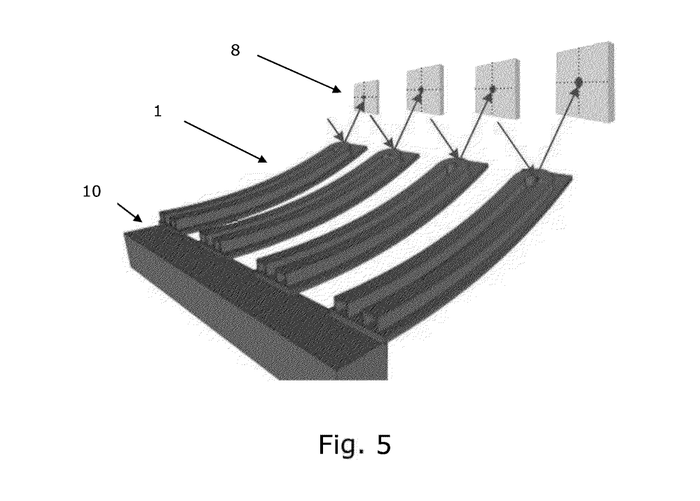

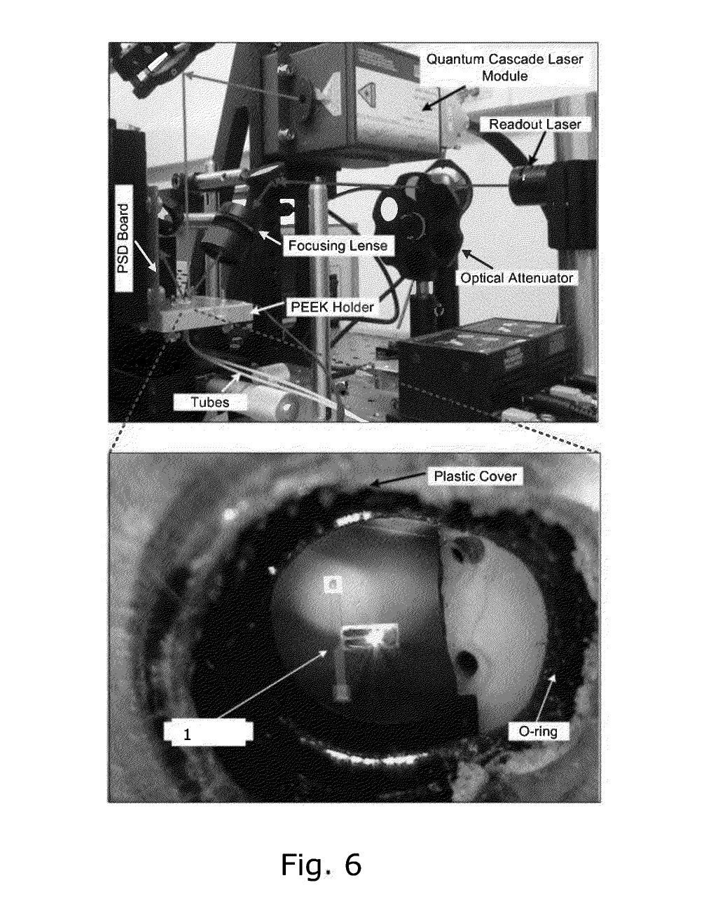

Reference is made to FIG. 5 which shows schematically a preferred embodiment of a micro-channel photothermal analyser of microfluidic samples according to the present invention. In this embodiment, the analyser comprising a plurality of oblong micro-channels 1 (being parallel arranged as shown in the figure) and a plurality of deflection detectors 8, the analyser being adapted to be used in an array configuration where the oblong micro-channels are loaded with different solutions to perform a parallel analysis of the solutions.

Reference is made to FIG. 4, which shows schematically a suitable set-up that can be used to provide a micromechanical photothermal analyser according to the present invention.

In a further embodiment (not shown in the figures) the first wall segment 4 is concave shaped and the second wall segment 11 is plate shaped. Thus, the first wall 4 segment may be viewed as constituting an open channel like a groove. The channel is closed by the first wall segment 4 being sealingly joined (to provide a fluid tight seal) with the second wall segment (11) whereby the concavity of the first wall segment is closed by the second wall segment (11) thereby defining the channel (2).

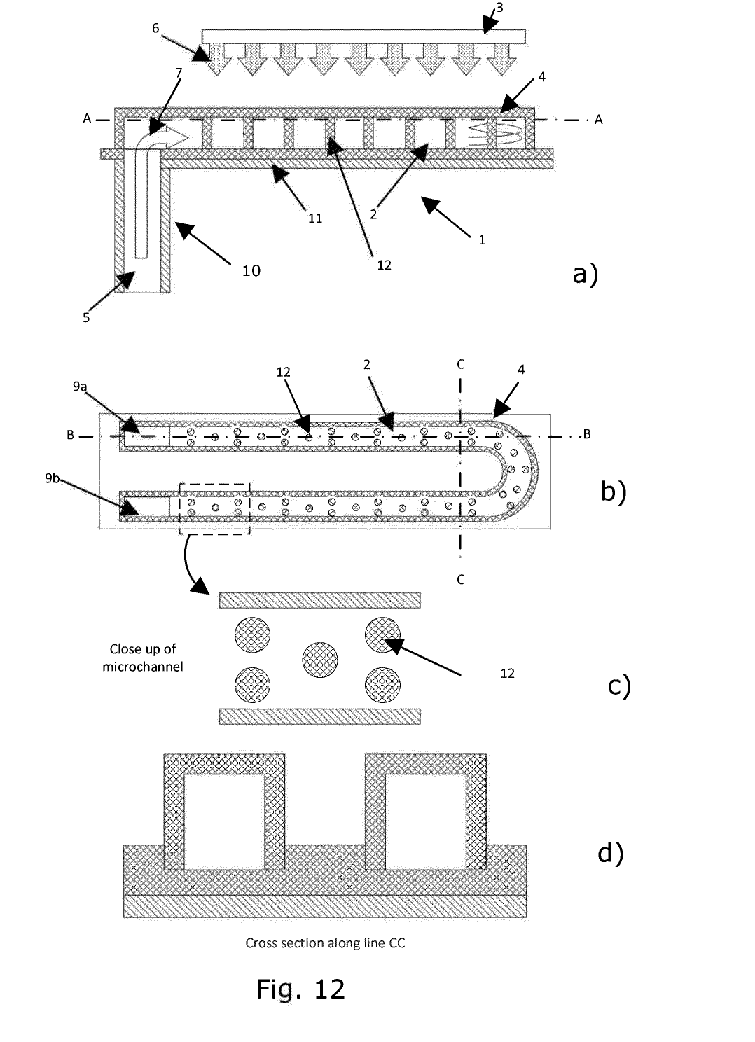

Reference is made to FIG. 12, which shows schematically a micro-channel according to a preferred embodiment of the invention. As it appears from FIG. 12, the micro-channel 1 of FIG. 12 is similar, such as identical with the micro-channel disclosed in FIG. 1, except that the micro-channel of FIG. 12 comprises micro-pillars 12 extending vertically inside the interior of the micro-channel. Accordingly, the numerals used in connection with FIG. 1 are used for similar elements in FIG. 12. FIG. 12a shows a vertical cross sectional view along line B-B of FIG. 12b which shows a horizontal cross sectional view along line A-A in FIG. 12a.

As in the embodiment of FIG. 1, the oblong micro-channel 1 of FIG. 12 is U-shaped extending longitudinally, and preferably in a horizontal direction, from a support element 10. It is noted, that the U-shape is a preferred embodiment and that the oblong micro-channel 1 may be given other shapes deviating from the U-shape.

Again, the micro-channel is made from at least two materials with different thermal expansion coefficients, wherein the materials are arranged relatively to each other so that heating of the micro-channel 1 results in a bending of the micro-channel 1. The first material has a first thermal expansion coefficient and is made from a light-specific transparent penetrable material so that when exposed to UV, VIS, or IR light, the specific light radiates into the channel 2 through said light-specific transparent material. The second material has a second thermal expansion coefficient being different from the first thermal expansion coefficient.

As shown in FIG. 12, the micro-channel 1 comprises a first wall segment 4 and a second wall segment 11 each forming at least a part of an upper respectively lower wall of the micro-channel 1. The first wall segment 4 extends longitudinally above—or in general along—the second wall segment 11 and wherein first wall segment 4 is made from the first material and the second wall segment 11 is made from the second material. As apparent from FIG. 12, the upper part of the first wall segment 4 (the part of the first wall segment facing towards the irradiation source) allows infrared light to be radiated into the interior 2 of the channel 1.

The first wall segment 4 defines the interior 2 of the micro-channel 1 and the second wall segment 11 is arranged, such as constitute a coating, on a lower surface of the first wall segment 4, or, in general, is arranged such as constituting a coating on a longitudinal extending surface of the first wall segment 4.

The liquid—or fluid in general—to be analysed is contained in the interior 2 of micro-channel 1 extending inside the oblong micro-channel 1 in the longitudinal direction of the oblong micro-channel 1.

The working principle due to the difference in thermal expansion coefficients is as disclosed in connection with inter alia FIG. 1. Further, the micromechanical photothermal analyser comprising the micro-channel of FIG. 1 comprises as in FIG. 1 an irradiation source 3 being adapted to ray UV, VIS, or IR light 6 towards and through the first wall segment 4 as disclosed in connection with e.g. FIG. 1. Thereby, the fluid is heated which will cause a heating of the micro-channel 1 resulting in a bending thereof.

As shown in FIG. 12, the micro-channel comprises micro-pillars 12 in the interior of micro-channel 2. The micro-pillars 12 extend vertically between an upper and lower interior surface of the micro-channel 1 as disclosed in FIG. 12a. The micro-pillars may at their distal ends be made integral with or fixed to the inner surfaces of the micro-channel 1. The pillars 12 offer structural support and also increase surface area inside the micro-channel which may enhance molecule binding. The micro-pillars may be arranged in different patterns where one such pattern (alternating between one and two pillars 12 transverse to the longitudinal direction of the channel) is shown in FIGS. 12b and 12c.

The pillars 12 are typically equal to each other and are shaped as rods having a cylindrical outer shape. The height of the pillars equal the height of the interior of the channel and the diameter (or an equivalent diameter D=sqrt (4/π*cross sectional area) is typically selected smaller than ½ the width, such as smaller the ⅓ the width, and even smaller than ¼ the width of a channel branch. As indicated by the wording “micro-pillars” the dimensions of such elements are typically in the micro-meter range; however, the may also be in the nano-meter range.

As disclosed inter alia with reference to FIG. 2, a micromechanical photothermal analysis method is performed by use of a micromechanical photothermal analyser according to the present invention. Such methods typically and preferably comprises the steps of
arranging a fluid inside the micro-channel 1,
emitting UV, VIS, or IR lights towards and through the light-specific transparent part of the micro-channel by use of the irradiation source 3,
detecting by use of the deflection detector 8, the deflection of the micro-channel,
characterize the fluid arranged inside the micro-channel based on the light wavelength dependent deflection.

The emission of light is typically carried out at a plurality of different wave lengths.

The determination of the fluid is based on a database look-up, the database is storing experimentally obtained correlations between deflections and substances. Usually, such a database may advantageously be developed by use of conventional IR spectroscopy.

### FURTHER DETAILS AND ASPECTS OF THE INVENTION

In the following, further details and aspects of the invention will be presented.

Conventional IR microspectroscopy, which relies on Beer-Lambert's law, is based on detecting small intensity changes in the transmitted light through the sample using a cooled IR detector in a large inherent IR background. Increasing the incident IR power increases the background signal without enhancing the signal-to-noise ratio (SNR). In contrast, in calorimetric IR spectroscopy the IR absorption induces changes in the sample temperature, which results in an enhanced SNR with increasing incident IR power. IR absorption-induced temperature changes can be measured if the sample is deposited on a bi-material oblong micro-channel, which undergoes bending in proportion to the changes in its temperature. IR spectra of solid phase materials with mass in the range of tens of picogram placed on a bi-material oblong micro-channel have been measured using this calorimetric approach where the sample is illuminated with IR light from a quantum cascade laser. The mechanical bending of the oblong micro-channel as a function of illuminating wavelength resembles the conventional IR absorption spectra of the sample. However, IR characterization of similar amounts of liquids using this calorimetric method remained as challenge until now. IR characterization of very small amount of liquids has a plethora of potential applications, for example drug screening in pharmaceutical industry and characterization of samples in biomedical applications.

Reference is made to FIG. 2 which discloses device concepts referenced a, b, and c.
a. A bimetallic oblong micro-channel is irradiated with an IR light using a tunable source. The spot diameter of the IR beam is about 4 mm therefore whole oblong micro-channel is fully covered with IR light. The cross sectional view presents the micro-channel of the oblong micro-channel filled with ethanol. As the molecules of the analyte absorb IR radiation at their characteristic resonance frequency, local heat is generated as a result of non-radiative decay process. Because of different rate of thermal expansion of aluminum and silicon nitride, the oblong micro-channel deflects upwards.
b. A precise IR spectrum of the analyte can be generated by plotting amplitude of deflections of the oblong micro-channel as a function of IR wavenumber.
c. The oblong micro-channel structure vibrates with a certain resonance frequency which depends upon mass and spring constant of the structure. As the micro-channel is filled with an analyte, the total mass of the structure changes thus the resonance frequency shifts to a lower value. Density of the analyte can be extracted from the frequency shift.

The present invention offers an elegant technique for obtaining the IR absorption spectrum as well as density of the confined fluid in real time. In this invention, picoliter volume of fluid sample contained in the microfluidic channel on top of a bi-material oblong micro-channel absorbs IR photons at a certain wavelength and releases the energy to the phonon background of the bi-material micro-channel through multiple steps of vibrational energy relaxation. These nonradiative decay processes result in minute change in the temperature of the bi-material oblong micro-channel because of its low thermal mass, generating a measurable deflection of the oblong micro-channel (FIG. 2a). The nanomechanical IR spectrum, a differential plot of the amplitude of the oblong micro-channel deflection as a function of impinging IR wavenumber with and without liquid sample, represents molecular vibrational signatures of the liquid analytes (FIG. 2b)while the resonance frequency change of the micro-channel analyzer gives real time information of the density of the fluid sample (FIG. 2c). Since the volume of the microfluidic channel on top of the oblong micro-channel is fixed, the mass of the fluid sample can be directly determined with density-frequency calibration measurements.

Reference is made to FIG. 2 disclosing experimental setups:
a. Top view of a chip containing an oblong micro-channel, sample delivery channels and inlet/outlet. The insert provides a side view showing micro-channel (in gold), metal layer (in blue) and substrate (in grey). On a silicon substrate, the oblong micro-channel is fabricated by silicon-rich silicon nitride.
b. The chip is packaged in a PEEK (Polyether ether ketone) fixture through which the inlet of the chip is connected with a sample reservoir and outlet is connected with a syringe pump—instead of PEEK, it could also be made from other materials like Teflon, aluminium etc. Throughout the measurements, the oblong micro-channel as well as analyte are kept at atmospheric pressure and room temperature. However, this represent a current preferred experimental set-up and deviations from this are envisaged; that is e.g. different pressure and/or temperature levels.
c. Using a tunable quantum cascade laser, the oblong micro-channel is irradiated with a series of different wavelengths of IR light. The deflection of the oblong micro-channel is measured by reflecting a visible laser (635 nm) to a position sensitive detector. For the simplicity, a micro-channel is not shown on top of the oblong micro-channel.

Introduction to the Oblong Micro-Channel Chip

The oblong micro-channel is fabricated with silicon rich silicon nitride (SRN) thus producing a transparent micro-channel (refractive index 2.02) in the visible spectrum. On four inch wafers, 10 mm×5 mm oblong micro-channel chips are fabricated at Danchip (nanofabrication facility in Denmark) at the Technical University of Denmark. On a 350 μm thick substrate, 500 nm thick SRN film is deposited. This lays down the bottom of the oblong micro-channel. This is followed by 3 μm thick layer of poly silicon as a sacrificial material. The patterned sacrificial layer is covered by another SRN thus making walls and top of the oblong micro-channel. All thin film deposition is performed by low pressure chemical vapor deposition (LPCVD) technique. Later, the sacrificial material is etched by wet etching using potassium hydroxide (KOH) at 80° C. Depending upon the length of an oblong micro-channel, the wet etching may take up to 18 hours in completely removing the sacrificial material thus forming micro-channels. Etching of SRN is almost negligible in KOH. Additionally the low stress nature of silicon nitride helps significantly in keeping the microchannel free of cracks. 350 μm thick substrate is particularly used to keep inlet (on back side of the chip) to be 550 μm wide which creates an opening of 100 μm on top side by KOH etching while following the anisotropic Si etch along 111 plane.

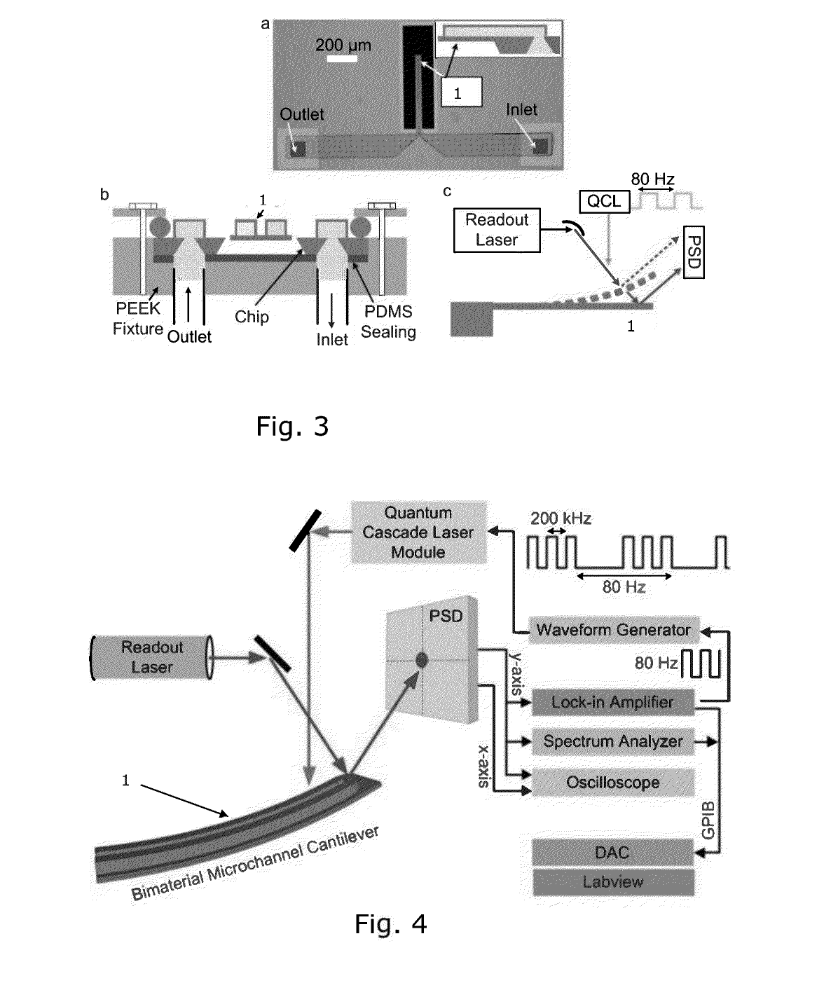

U-shaped microfluidic channel with dimensions of 16 μm in width, 1000 μm in length, and 3 μm in height is fabricated on top of a plain oblong micro-channel with dimensions of 44 μm in width, 500 μm in length, and 500 nm in thickness. This oblong micro-channel structure is rendered into a bi-material beam by depositing a 500 nm thick layer of aluminum on its bottom side using e-beam evaporation. This bi-material oblong micro-channel is supported on a 350 μm thick silicon chip, which provides two fluidic inlet and outlet (3×150 μm², height×width) for delivering samples into the micro-channel on the oblong micro-channel (FIG. 3a). The silicon chip has two openings (inlet/outlet) at the bottom, which provide a fluidic interface between the chip and Teflon tubes with inner diameter of 800 μm (FIG. 3b). The oblong micro-channel is provided with sample delivery channels (SDC) which are 3 μm high, 150 μm wide and 900 μm long. The SDC's are supported by micropillars (diameter: 5 μm) which avoid SDC's collapsing when vacuum is created inside the channels to pull a liquid sample inside.

The chip containing an oblong micro-channel and sample delivering channels is packaged in a holder made of polyether ether ketone (PEEK) that provides a connection with larger tubes to deliver a fluid sample to the oblong micro-channel.

The sealed contact between PEEK holder and the chip is achieved by placing a polydimethylsiloxane (PDMS) gasket and pressing the top of the chip by an O-ring made of nitrile butadiene rubber (NBR) (FIG. 3b). To load a fluid sample inside the oblong micro-channel, a syringe pump is connected at the outlet tube to create a negative pressure (maximum of 1000 mbar) to pull the fluid sample from inlet to outlet while passing through the oblong micro-channel. Since the microfluidic channels are optically transparent, the fluid sample entering the oblong micro-channel can be visually observed using a microscope.

Measurement Setup

An external-cavity Quantum Cascade Lasers (QCLs) (from Daylight Solutions) are used as a source of infrared (IR) light. General advantages of QCLs over a thermal IR source are; pulsed operation (up to 200 kHz), high optical power (up to 500 mW peak power), operation at room temperature, broad tunability, high spectral resolution (down to 0.1 nm) and compact assembly. For our experiments, the three QCL lasers are used (MIRCat™ (bandwidth: 6 μm to 13 μm), UT-7 (bandwidth: 6.4 μm to 7.4 μm, i.e. 1540 cm⁻¹ to 1345 cm⁻¹) and UT-8 (bandwidth: 7.1 μm to 8.7 μm, i.e. 1408 cm⁻¹ to 1145 cm⁻¹)).

The UT-8 QCL is pulsed at 200 kHz while UT-7 and MIRCat™ are pulsed at 100 kHz. The 100 or 200 kHz pulsed IR light with 5 or 10% duty cycle from three different quantum cascade lasers (QCL) is electrically burst at 80 Hz, directed to the oblong micro-channel, and scanned sequentially with a spectral resolution of 2 nm. This means that the cantilever is exposed to IR pulse every 12.5 milliseconds or 6.25 milliseconds. This time period is enough to provide thermal relaxation to the oblong micro-channel. To find amplitude of a signal at 80 Hz, the signal from the y-axis of the PSD is fed into a lock in amplifier (SR-850 from Stanford Research Systems). To continuously measure resonance frequency of the oblong micro-channel, a spectrum analyzer is used to measure fast Fourier transform (FFT) of the signal from the y-axis of the PSD. An oscilloscope is used to monitor and keep the laser spot in the center of the sensitive area of PSD. The data from the lock-in-amplifier and the spectrum analyzer are stored in a computer using a data acquisition card and a Labview program. Later the signal is plotted with respect to wavelength of IR light thus generating an IR spectrum of an analyte inside the oblong micro-channel. (FIG. 4).

The photothermal oblong micro-channel deflection signal and the resonance frequency of the oblong micro-channel are simultaneously measured by optical beam deflection method where a probing red laser (with a spot size of about 50 μm) is reflected to a four quadrant position sensitive detector (PSD) (FIG. 3c). An oblong micro-channel without any fluid inside (empty) has the fundamental resonance frequency of approximately 24 kHz.

Loading Liquid samples

To load a sample inside the oblong micro-channel, a vacuum pump is connected at the outlet tube which creates a pressure difference of 1000 mbar. This pulls a liquid sample inside the oblong micro-channel. Due to hydrophilic nature of SRN, a liquid sample instantly fills the micro-channel. The presence of a sample inside the oblong micro-channel is verified visually (through the transparent SRN channel) and change in its resonance frequency. For a new sample, generally a sample of up to 2 μL is loaded while for established experiments a sample as low as 500 pL is enough. The IR spectrum is collected with the 50 pL of a liquid sample which is inside of the oblong micro-channel located on top of the oblong micro-channel. The well-sealed packaging makes it convenient to measure IR spectrum of volatile liquid samples. Once an IR spectrum is measured, the sample is unloaded by applying a negative pressure at outlet of the chip. The chip is flushed with ethanol and water to remove residues of the sample.

Loading Solid/Viscous Samples

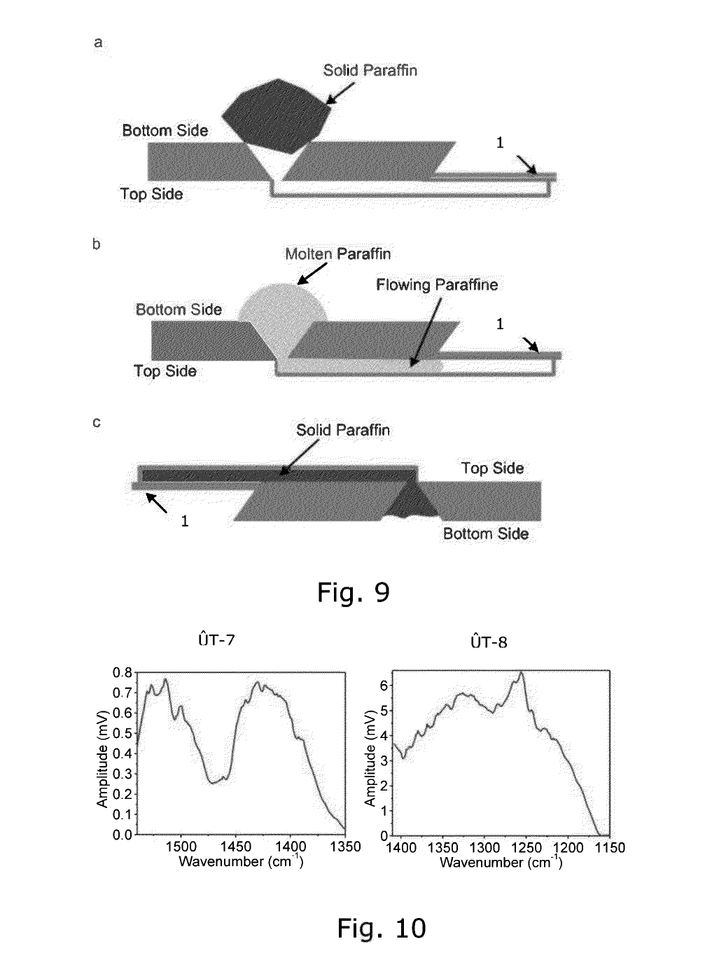

The oblong micro-channel is not only for liquid samples but it also has a capability to measure IR spectrum of samples which exist in solid or very viscous state. To take a measurement, the oblong micro-channel should be completely filled with a sample. In our experiments, a small quantity of such samples is placed on the backside of the oblong micro-channel ship, as shown in FIG. 9a. The chip is heated to the melting temperature of the sample. The molten sample flows inside the channel due to strong capillary forces, as shown in FIG. 9b. Once the oblong micro-channel is filled with the sample, the oblong micro-channel (thus the sample inside the oblong micro-channel) is cooled down to room temperature to measure IR spectrum of the sample. FIG. 9c shows a oblong micro-channel filled with a solid sample. One disadvantage of this method is that after the measurement, the sample could not be removed completely therefore making the whole chip disposable.

IR Spectrum of an Empty Oblong Micro-Channel

In our experiments, as an analyte (in liquid or solid state) is placed in an oblong micro-channel and the oblong micro-channel is irradiated with IR light, the analyte as well as material (SRN) of the oblong micro-channel both absorb the photons at the respective resonance frequencies of their molecules. To get a distinct spectrum of an analyte, it is important to subtract the IR spectrum of SRN. For this purpose IR spectra (using all QCL modules) of an empty oblong micro-channel are measured as a baseline or background (as called in conventional IR spectroscopy) at a room temperature and atmospheric pressure. All subsequent measurements are performed at same ambient conditions. FIG. 10 shows IR spectrum of oblong micro-channel filled with air. The IR intensity (from the QCL sources) is not uniform throughout the bandwidth. UT-7 and UT-8 have maximum energy at about 1430 cm⁻¹ and 1304 cm⁻¹ respectively and minimum at 1340 cm⁻¹ and 1145 cm⁻¹ respectively. As a baseline, the spectrum shows the oblong micro-channel defection as broad upwards peaks. Therefore we can see that SRN absorbed IR at about 1520 cm⁻¹, 1420 cm⁻¹, 1325 cm⁻¹, and 1250 cm⁻¹.

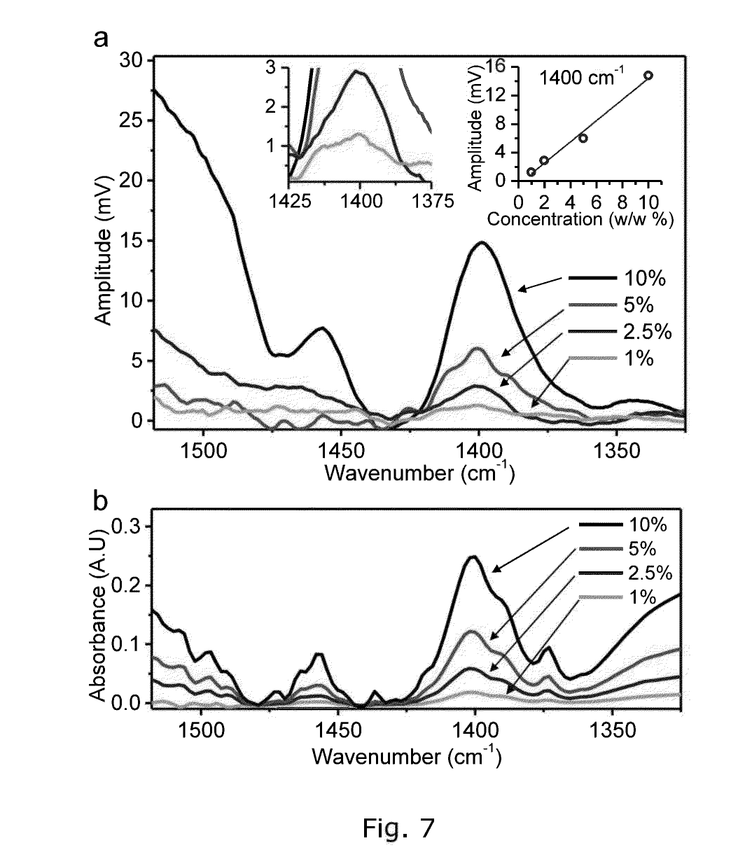

Reference is made to FIG. 7 which discloses IR spectra of 50 picoliters of an antimicrobial drug:
a. Nanomechanical IR spectra of ampicillin sodium salt, antibacterial drug, are measured using an oblong micro-channel. As the drug exits in a solid form, it is dissolved in water to be loaded in the oblong micro-channel. Four samples with different concentrations (w/w %) of the drug are prepared. The microfluidic setup (shown in FIG. 3b) is used to load the sample into the oblong micro-channel. The oblong micro-channel is irradiated with IR light from 1518 cm⁻¹ to 1325 cm⁻¹. Ampicillin sodium salt molecules absorb IR photons at 1456 cm⁻land 1400 cm⁻¹. The left insert is zoomed in window for the concentration of 1% and 2.5%. The right insert shows a linear trend in peak amplitude as a function of the concentration of ampicillin sodium salt.
b. FTIR ATR spectra are presented to compare the performance of the oblong micro-channel with a commercial apparatus. At 1400 cm⁻¹ good degree of match between both results is found.

To demonstrate the capability of the calorimetric IR microspectroscopy with an oblong micro-channel, nanomechanical IR spectra of ampicillin sodium salt (C₁₆H₁₈N₃NaO₄S), antimicrobial drug agent, dissolved in de-ionized water with a concentration of 1, 2.5, 5, and 10% (w/w) are taken and compared with the conventional Fourier transform infrared (FTIR) spectra in attenuated total reflection (ATR) mode (FIG. 7). Several distinct peaks and shoulders appear in nanomechanical IR spectra and two strong absorption peaks at 1456 cm⁻¹ and at 1400 cm⁻¹ (FIG. 7a) which attribute to aromatic C-C stretching and C—H deformation, respectively, are clearly matched between nanomechanical IR spectra and FTIR spectra (FIG. 7b). The insert in FIG. 7a shows the nanomechanical IR absorption peak amplitudes at 1400 cm⁻¹ as a function of ampicillin sodium salt concentration and the straight line is the linear fit of the peak amplitudes. The limit of detection for ampicillin sodium salt at this wavenumber is estimated to be 0.6% with an SNR of 3a. Additionally due to low thermomechanical sensitivity of the oblong micro-channel, nanomechanical IR absorption peaks at 1456 cm⁻¹ with concentrations lower than 10% are missing.

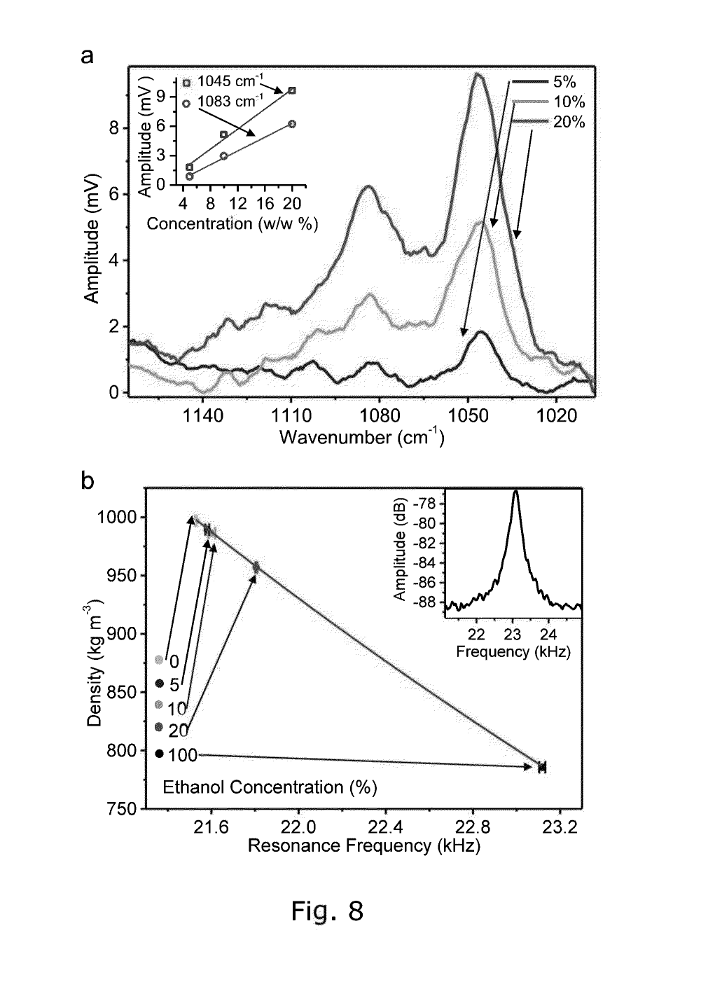

Reference is made to FIG. 8 which discloses sensitivity of the oblong micro-channel:
a. The sensitivity of the oblong micro-channel is qualitatively tested by measuring IR spectra of 50 picoliters of different concentrations (w/w %) of ethanol in ethanol/water binary solutions. Single oblong micro-channel is used to measure the spectra where de-ionized water is used as a background. By keeping the experimental conditions constant, a strong dependence of IR absorption (thus oblong micro-channel deflection) and concentration of an analyte is observed. The insert shows linear trend between different concentrations of ethanol and deflections amplitude of the oblong micro-channel.
b. In dynamic mode, the resonance frequency of the oblong micro-channel is also recorded before and after loading a solution in the micro-channel. Depending upon the density of the binary solutions, each time the resonance frequency of the device is different. After each test, the oblong micro-channel chip is cleaned by evaporating solution inside. Full cleanliness is insured by regularly measuring the frequency of the empty oblong micro-channel. Violet colored line shows a fit of equation (2) with the data. The insert shows a Fourier spectrum of the first mode of the oblong micro-channel with 100% ethanol at 23.1 kHz. All measurements were performed at atmospheric pressure and room temperature.

To illustrate the capability of quantitative measurement and analysis, a oblong micro-channel is used to measure IR spectra of water-ethanol binary solutions with different concentrations of ethanol. Starting with 5% ethanol in a solution, the oblong micro-channel is irradiated with IR light from 1180 cm⁻¹ to 1000 cm⁻¹. All ethanol/water binary solutions exhibit strong peaks at 1087 cm⁻land 1053 cm⁻¹ revealing C—O—H bending and C—O stretching respectively (FIG. 8a). Keeping all the experimental conditions unaltered, it can clearly be seen that the amplitude of oblong micro-channel deflection is directly proportional to the concentration of the analyte. Like ampicillin drug measurements, there is also a linear trend between the peak amplitude and the concentration of ethanol, as shown in the insert of FIG. 8a. By extrapolation, such trend can be exploited to determine the concentration of ethanol in an unknown solution.

IR Spectrum of Multiple Analytes

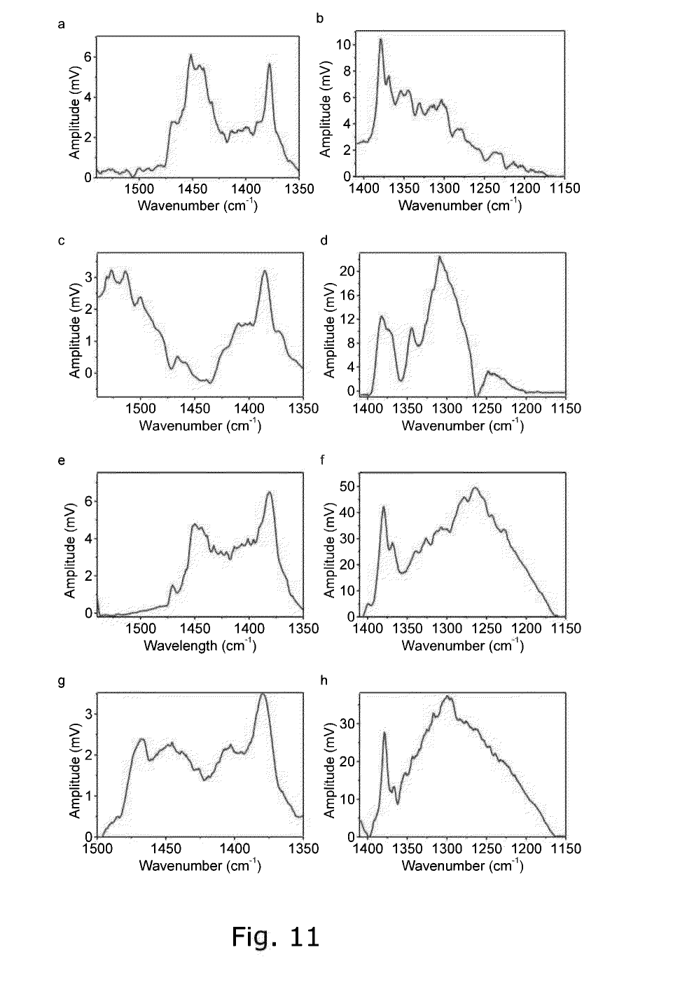

Using the oblong micro-channel, we measured IR spectra of multiple organic analytes which includes n-hexadecane, isopropanol, naphtha, and paraffin. As all chemicals have common CH₃ molecules so strong peaks are measured at 1380 cm⁻¹ and 1460 cm⁻¹ exhibiting symmetric and asymmetric CH₃ deformation respectively. In addition to that isopropanol shows C—OH bending at 1250 cm⁻¹ and CC—H in plane bending at 1345 cm⁻¹. Paraffin and isopropanol exhibits CH₂ twisting at 1308 cm⁻¹ while at 1470 cm⁻¹ paraffin exhibits CH₂ bending. After smoothing by Savitzky-Golay filter the data is plotted in FIG. 11.

This capability the oblong micro-channel of chemical characterization of liquids (by measuring IR spectra) is complemented with the quantitative measurement of physical properties of the liquids. The fundamental resonance frequency of an oblong micro-channel, f₀, can be modeled as that of a solid oblong micro-channel with a changing density, given by

$${f}_{0} = \frac{{λ}_{o}^{2}}{2 π} \frac{h}{{L}^{2}} \sqrt{\frac{E}{12 ( {V}_{c} {ρ}_{c} + {V}_{f} {ρ}_{f} )}} \qquad ( 1 )$$

where λ₀ is a constant related to the fundamental mode of the oblong micro-channel vibration (λ₀=1.875), h, L, E are the effective thickness, the effective length, and the effective Young's modulus of the oblong micro-channel, respectively, V_{c} is a volume fraction of the oblong micro-channel, ρ_{c} is the effective mass density of the oblong micro-channel, V_{f} is a volume fraction of the fluid in the micro-channel and ρ_{f} is the mass density of the fluid in the micro-channel. With the assumption that the fluid in the micro-channel does not change the effective Young's modulus of the oblong micro-channel, Eq. 1 can be simplified to:

$${f}_{0} = \frac{A}{\sqrt{B + {ρ}_{f}}} \qquad ( 2 )$$

where A and B are constants which can be determined from the resonance frequency measurements of two different fluids with well-known mass densities, such as ethanol and de-ionized water. With determined A and B of the oblong micro-channel, the mass density of the fluid in the micro-channel can be determined by

$${ρ}_{f} = {( \frac{A}{{f}_{0}} )}^{2} - B \qquad ( 3 )$$

Fundamental resonance frequencies of the oblong micro-channel are measured with three ethanol/water binary mixtures having 5, 10, and 20 mass percent of ethanol. The density is calculated from Eq. 2 (FIG. 8b). As the ethanol content decreases, the density of the binary solutions increases thus the resonance frequency of the oblong micro-channel decreases. A fit function (Eq 2) can help in finding the density of a water-ethanol binary mixture with unknown ethanol concentration.

Irrespective to a light source (ultraviolet, visible or IR), the oblong micro-channel can be effectively used as a miniature micromechanical photothermal analyser to show absorption of picoliter volume of a solution at specific wavelengths of light.

For a proof of concept, it is only demonstrated to measure nanomechanical spectra of ampicillin sodium salt and ethanol solutions. In future, we would like to identify cancer cells, pharmaceutical formulations and more complex chemicals through their interaction with light. Due to mass production and miniature size, the oblong micro-channel chips would be used in an array configuration to assess multiple analytes at a time. In our experiments, due to limited spectrum range of QCL sources, the oblong micro-channel could not be used over a large bandwidth but as the technology advances with external cavity lasers, we hope to get a QCL with a broader wavelength range.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A micromechanical photothermal analyser of microfluidic samples comprising:
an oblong micro-channel extending longitudinally from a support element, the micro-channel being made from at least two materials with different thermal expansion coefficients, wherein:
the first material has a first thermal expansion coefficient and is made from a light-specific transparent penetrable material,
the second material has a second thermal expansion coefficient being different from the first thermal expansion coefficient,
the oblong micro-channel comprises a first wall segment and a second wall segment, the first wall segment extends longitudinally along the second wall segment, and
the first wall segment is made from the first material and the second wall segment is made from the second material,
an irradiation source configured to radiate ultraviolet, visible, or infrared light towards and through the first material, and
a deflection detector being adapted to detect the amount of deflection of the micro-channel (1).

2-17. (canceled)

18. The micromechanical photothermal analyser of microfluidic samples according to claim 1, wherein the first wall segment defines the interior of the micro-channel and the second wall segment is arranged on a longitudinal extending surface of the first wall segment.

19. The micromechanical photothermal analyser of microfluidic samples according to claim 1, wherein the first wall segment is concave shaped and the second wall segment is plate shaped, the first wall segment being sealingly joined with the second wall segment so that the concavity of the first wall segment is closed by the second wall segment thereby defining the channel.

20. The micromechanical photothermal analyser of microfluidic samples according to claim 1, wherein the micro-channel has a cross-section.

21. The micromechanical photothermal analyser of microfluidic samples according to claim 1, wherein the micro-channel comprises an inlet and an outlet configured to pass a fluidl.

22. The micromechanical photothermal analyser of microfluidic samples according to claim 1, wherein the channel is U-shaped with each branch extending in the longitudinal direction of the micro-channel, and an opening, serving as inlet/outlet, is provided at each branch of the channel distal to the bend of the U-shaped channel.

23. The micromechanical photothermal analyser of microfluidic samples according to claim 1, wherein the first material is silicon nitride, silicon, silicon oxide, of a polymer and the second material is a metal, the first material being transparent to light within the infrared, ultraviolet, or visible light range.

24. The micromechanical photothermal analyser of microfluidic samples according to claim 1, wherein the irradiation source is configured to irradiate pulsed or continuous wave light.

25. The micromechanical photothermal analyser of microfluidic samples according to claim 1, wherein the irradiation source is configured to irradiate light at difference wavelengths.

26. The micromechanical photothermal analyser of microfluidic samples according to claim 1, wherein the irradiation source is configured to irradiate radiowaves at different wavelengths.

27. The micromechanical photothermal analyser of microfluidic samples according to claim 1, wherein the deflection detector comprises a laser emitting light extending towards the micro-channel in an oblique direction and a position sensitive detector arranged to receive the laser light reflected from the micro-channel.

28. The micromechanical photothermal analyser of microfluidic samples according to claim 1, wherein the deflection detector is integrated on the micro-channel, wherein the detector is piezo-electric, piezo-resistive, magnetomotive, or capacitive.

29. A micromechanical photothermal analyser of microfluidic samples according to claim 1, wherein the analyser comprising a plurality of oblong micro-channels and a plurality of deflection detectors, the analyser being adapted to be used in an array configuration where the oblong micro-channels are loaded with different solutions to perform a parallel analysis of the solutions.

30. The micromechanical photothermal analyser according to claim 1, wherein the oblong micro-channel comprises micro-pillars in the interior of micro-channel, the micro-pillars extending transverse to the longitudinal direction of the micro-channel.

31. A method of using the micromechanical photothermal analyser of claim 1 comprising:
arranging a fluid (liquid and/or gas) inside the micro-channel of the micromechanical photothermal analyser of claim 1,
emitting ultraviolet, visible, or infrared light towards and through the transparent part of the micro-channel by use of the irradiation source,
creating heat inside the micro-channel as a result of light absorbance by the substance inside the channel,
depending upon the difference in the thermal coefficient, deflecting the micro-channel,
analysing by use of the deflection detector, the deflection of the micro-channel, and
characterizing the fluid arranged inside the micro-channel based on the light wavelength dependent deflection.

32. The micromechanical photothermal analysis method of microfluidic samples according to claim 31, comprising emitting light at a plurality of different wave lengths.

33. The micromechanical photothermal analysis method according to claim 31, wherein the determination of the fluid is based on a database look-up, wherein the database stores experimentally obtained correlations between deflections and substances.
